(19) United States
(12) Patent Application Publication
(10) Pub. No.: US 2016/0236225 A1
(43) Pub. Date: Aug. 18, 2016

(54) COATER

(71) Applicant: HEWLETT-PACKARD DEVELOPMENT COMPANY, L.P., Houston, TX (US)

(72) Inventor: Jacob Tyler WRIGHT, San Diego, CA (US)

(73) Assignee: HEWLETT-PACKARD DEVELOPMENT COMPANY, L.P., Houston, TX (US)

(21) Appl. No.: 15/024,914

(22) PCT Filed: Oct. 24, 2013
(86) PCT No.: PCT/US2013/066656

§ 371 Date: Mar. 25, 2016

(51) Int. Cl. B05C 1/08; B41C 1/00; B05D 1/28

(52) U.S. Cl. CPC B05C 1/0821; B05D 1/28; B05C 1/0856; B41C 1/00

(57) ABSTRACT

A coater comprising a transfer roller and an anilox roller, in which the coater may selectively change the direction of rotation of the transfer roller while the anilox roller maintains a singe direction of rotation.

### BACKGROUND

Web coating is a process by which a medium is coated with a coating either before or after an image is printed on the medium. Reverse kiss coating may be used to apply thick coatings of fluid to a high quality, non-absorbent medium Flexographic coating may be used on other mediums as well to produce a coating on relatively lower quality mediums.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a system for hybrid coating of a medium according to one example of principles described herein.

FIG. 2 is a block diagram showing a side cutout view of the number of rollers within the web coater of FIG. 1 according to one example of the principles described herein.

FIG. 3 is a block diagram showing a side cutout view of the number of rollers within the web coater of FIG. 1 according to another example of the principles described herein.

FIG. 4 is a flowchart showing a method of coating a medium according to one example of the principles described herein.

Throughout the drawings, identical reference numbers designate similar, but not necessarily identical, elements.

### DETAILED DESCRIPTION

As described above, web coating processes may include flexographic coating and reverse kiss coating. Flexographic coating, however, has some disadvantages. Flexographic coating produces ribbing when applying thick coatings of fluid to high quality, non-absorbent mediums. This may prevent flexographic waters from applying very thick coatings and coating comprising certain materials. These materials may be comprised of a chemistry that may make the materials relatively more prone to developing objectionable ribbing. Additionally, as the coat weight increases, the ribbing may become more pronounced. At coat weights of around 2-3 grams per square meter (GSM) are exceeded, the above coating defects begin to appear. Further, if an image was to be printed on the medium after such a coating has been applied, the fluid used to print the image may collect in the formed valleys of the ribbing while running off of the peaks creating an even more objectionable printed product.

Reverse kiss may also have limitations. Reverse kiss coating is not able to effectively coat low cost uncoated mediums. This may be due to a number of local topography high and low points in the paper. Because the high and low topographical points are present on the uncoated mediums, the high points may be coated, but the low points may remain dry causing the medium to not be uniformly coated.

A reverse kiss coater and a flexographic coater both have their disadvantages and advantages. In order for a printing service to handle all types of medium, two different waters are used: one to coat the relatively higher quality mediums and another to coat the relatively lesser quality mediums. This may lead to extra costs for a printer service, having to outsource a coating job to another source, or limiting the type of mediums a printer service may be able to coat.

The present application therefore describes a system for hybrid coating of a medium, comprising a computing device and a web water, the web coater comprising a transfer roller, in which the computing device may selectively use the transfer roller to reverse direction.

The present specification further describes coater comprising a transfer roller and an anilox roger, in which the coater may selectively change the direction of rotation of the transfer roller.

The present specification further describes a method of coating a medium, comprising introducing medium into a coater, the coater comprising a transfer roller and selectively changing the direction of rotation of the transfer roller.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “a number of” or similar language is meant to be understood broadly as any positive number comprising 1 to infinity; zero not being a number, but the absence of a number.

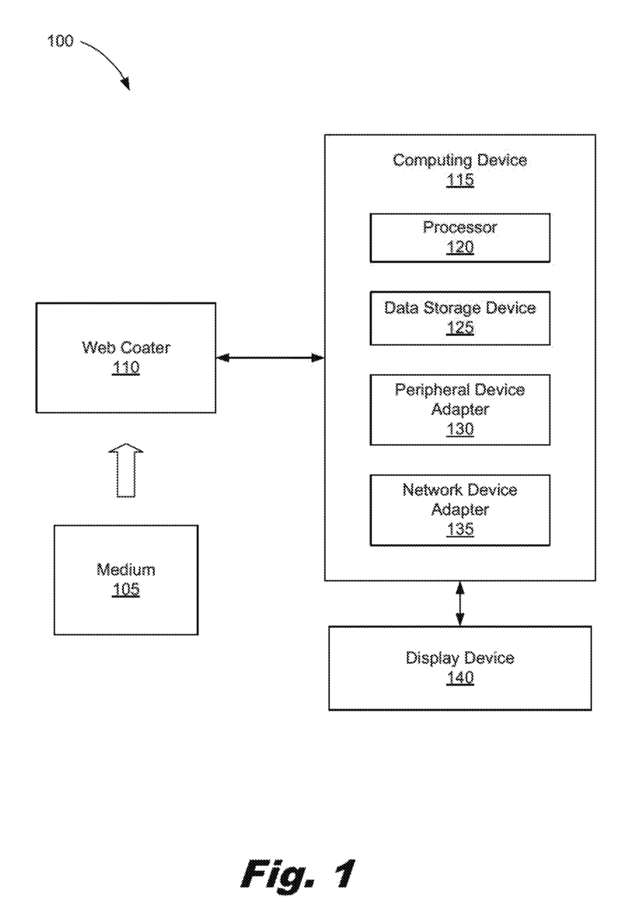

FIG. 1 is a block diagram of a system (100) for hybrid coating of a medium (105) according to one example of principles described herein. The system (100) comprises a web coater (110) and a computing device (115) communicatively coupled to the web coater (110). Although FIG. 1 shows the web coater (110) and the computing device (115) as separate entities, the present application contemplates that the web coater (110) may comprise a built-in computing device (115).

The computing device (115) may comprise a processor (120), a data storage device (126), a peripheral device adapter (130), a network device adapter (135), and a display device (140). These hardware components may be interconnected through the use of a number of busses and/or network connections. In one example, the processor (120), data storage device (125), peripheral device adapter (130), and network device adapter (135) may be communicatively coupled via a bus.

The processor (120) may include the hardware architecture to retrieve executable code from the data storage device (125) and execute the executable code. The executable code may, when executed by the processor (120), cause the processor (120) to implement at least the functionality of controlling the direction of rotation of the transfer roller within the web coater (110), according to the methods of the present specification described herein. In the course of executing code, the processor (120) may receive input from and provide output to a number of the remaining hardware units.

The data storage device (125) may store data such as executable program code that is executed by the processor (101) or other processing device. As discussed in more detail below, the data storage device (125) may specifically store computer instructions representing a number of applications that the processor (120) executes to implement at least the functionality described herein.

The data storage device (125) may include various types of memory modules, including volatile and nonvolatile memory. For example, the data storage device (125) of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device (125) as may suit a particular application of the principles described herein. In certain examples, different types of memory in the data storage device (125) may be used for different data storage needs. For example, in certain examples the processor (120) may boot from Read Only Memory (ROM), maintain nonvolatile storage in the Hard Disk Drive (HDD) memory, and execute program code stored in Random Access Memory (RAM).

Generally, the data storage device (125) may comprise a computer readable medium, a computer readable storage medium, or a non-transitory computer readable medium, among others. For example, the data storage device (125) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The peripheral device adapter and network device adapter (130, 135) enable the processor (120) to interface with various other hardware elements, external and internal to the computing device (115). For example, the peripheral device adapter (130) may provide an interface to input/output devices, such as, for example, the display device (140), a mouse, or a keyboard. The peripheral device adapter (130) may also provide access to other external devices such as an external storage device, a number of network devices such as, for example, servers, switches, and routers, client devices, other types of computing devices, and combinations thereof.

The display device (140) may be provided to allow a user of the computing device (115) to interact with and implement the functionality of the system and method described herein. The peripheral device adapter (130) may also create an interface between the processor (120) and the display device (140), a printer, the web coater (110), or other media output devices. The network adapter (135) may provide an interface to other computing devices within, for example, a network, thereby enabling the transmission of data between the computing device (115) and other devices located within the network.

Computer readable program instructions may, when executed by the processor (120), display, a number of graphical user interfaces (GUIs) on the display device (140) that represent a user interface by which a user may interact with the function of the web coater (110). The GUIs may display, for example, interfaces describing the functionality of the web water (110) as well as providing user selectable options by which a user may, at least, cause the transfer roller to be selectively change its rotation based on the type of medium (105) used. The user may further be able to select a type of medium to be coated with the web coater (110) and the computing device (115) may direct the web coater (110) to turn the transfer roller in the appropriate direction according to the type of medium selected by the user. In some instances, an impression cylinder in the web coater (110) may be brought closer or further away from the transfer roller according to the type of medium selected by the user on the GUI.

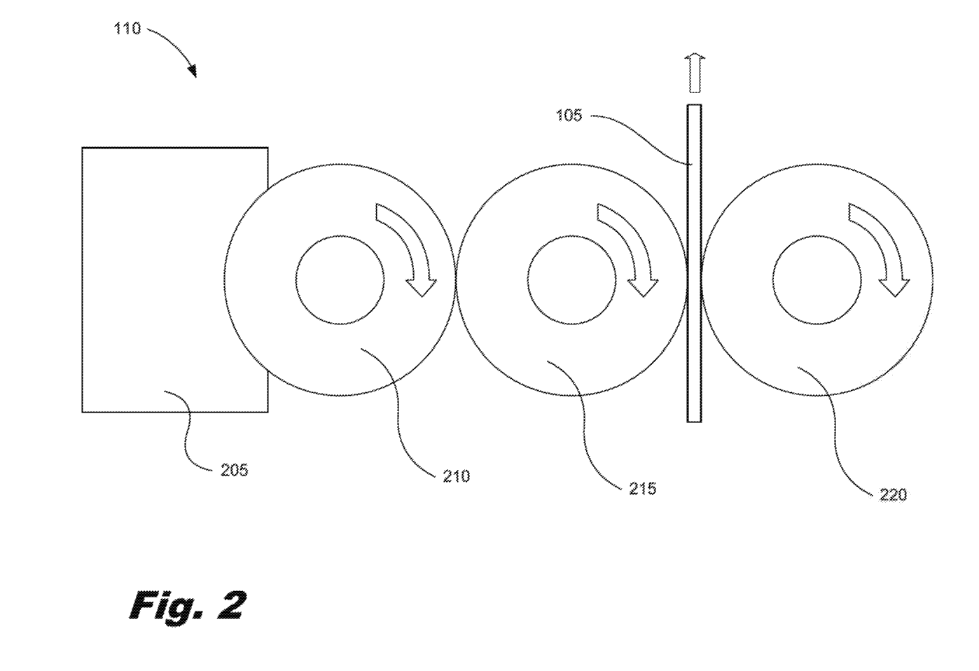

Turning now to FIG. 2, a block diagram showing a side cutout view of the number of rollers within the web coater (110) of FIG. 1 according to one example of the principles described herein. The web coater (110) may comprise a number of rollers including, but not limited to, an anilox roller (210), a transfer roller (215), and an impression cylinder (220). The web coater (110) may further comprise a fluid chamber (205). Each of these will be described in more detail below.

The anilox roller (210) is a roller that transfers a measured amount of fluid from the fluid chamber (205) to the transfer roller (215) when the anilox roller (210) is rotating either with or against the transfer roller (215). In one example, the fluid transferred by the anilox roller (210) may act as a lubricant at the interface between the anilox roller (210) and the transfer toiler (215). This example is shown in FIG. 2 where the anilox roller (210) is rotating in the opposite direction to and against the transfer roller (215).

The anilox roller (210) may be made of steel or aluminum core and coated with a ceramic. The ceramic surface comprises millions of very line dimples that help to transfer the fluid to the transfer roller (215). In one example, the anilox roller (210) may be partially submerged in the fluid chamber.

The transfer roller (215) may accept the fluid from the anilox roller (210) and transfer the thud to the medium (105). In one example, in order to transfer the fluid from the anilox roller (210) to the transfer roller (215) the distance between the anilox roller (210) and the transfer roller (215) may be around 1 to 2 thousands of an inch.

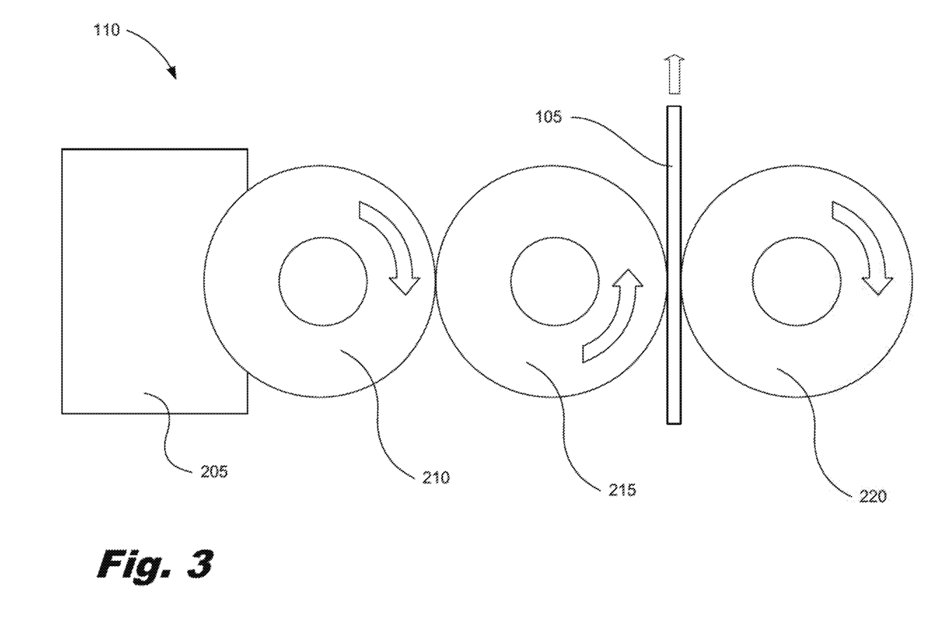

The impression cylinder (220) may help translate the medium (105) past the transfer roller (215). In one example, during a reverse kiss coating processes, such as that shown in FIG. 2, where the transfer roller (215) is rotating in the same direction as the anilox roller (210) and in the same direction as the impression cylinder (220), the impression cylinder (220) may translate the medium (105) through the web coater (110) with the help of other rollers. These other rollers may either push or pull the medium through the web coater (110). In an example during flexographic coating where the transfer roller (215) is rotating in an opposite direction as both the anilox roller (210) and the impression cylinder (220), the web coater (110) may use the opposing rotation of the transfer roller (215) and the impression roller (220) to translate the medium (105) through the web coater (110) as shown in FIG. 3.

As described above, the web coater (110) may selectively operate as a reverse kiss coater or a flexographic coater by selectively changing the rotation of the transfer roller (215). In one example, the transfer roller (215) may be coupled to an independent drive mechanism separate from any drive motor associated with either the anilox roller (210) or the impression cylinder (220). In another example, the transfer roller (215) may be operated via a 1-1 transmission which allows the transfer roller (215) to operate in both directions of rotation. Other examples exist where mechanical devices may selectively rotate the transfer roller (215) in opposite directions and the present specification contemplates those other mechanical devices.

In both FIGS. 2 and 3, the anilox roller (210) may continue to rotate in the same direction. FIGS. 2 and 3 show the anilox roller (210) rotating in the same direction as the impression cylinder (220). Because the transfer roller (215) may be selectively reversed, the anilox roller (210) may be rotated it a direction either opposite or with the transfer roller (215) depending on the selected direction of the transfer roller (215). In FIG. 2, the anilox roller (210) is rotating in a direction opposite that of the transfer roller (215). As described above, this allows the web coater (110) to coat a medium (105) using a reverse kiss coating method. While in operation, the fluid from the fluid chamber (205) may act as a lubricant between the anilox roller (210) and the transfer roller (215) and between the transfer roller (215) and the medium (105). This may be accomplished while still creating a sheering film split of the fluid between the anilox roller (210) and the transfer roller (215).

In FIG. 3, the anilox roller (210) is rotating with the transfer roller (215) as the direction of rotation of the transfer roller (215) is reversed as compared to that shown in FIG. 2. The rotation of the rollers (210, 215) provide for the web coater (110) to flexographically coat the medium (105). This too may be accomplished while still creating a sheering film split of the fluid between the anilox roller (210) and the transfer roller (215). Thus in either FIG. 2 or FIG. 3, the anilox roller (210) maintains its direction of rotation. Maintaining the direction of rotation on the anilox roller (210) provides for no ribbing appearing on the medium (105) while the web coater (110) is operated as a reverse kiss coater and a flexographic coater.

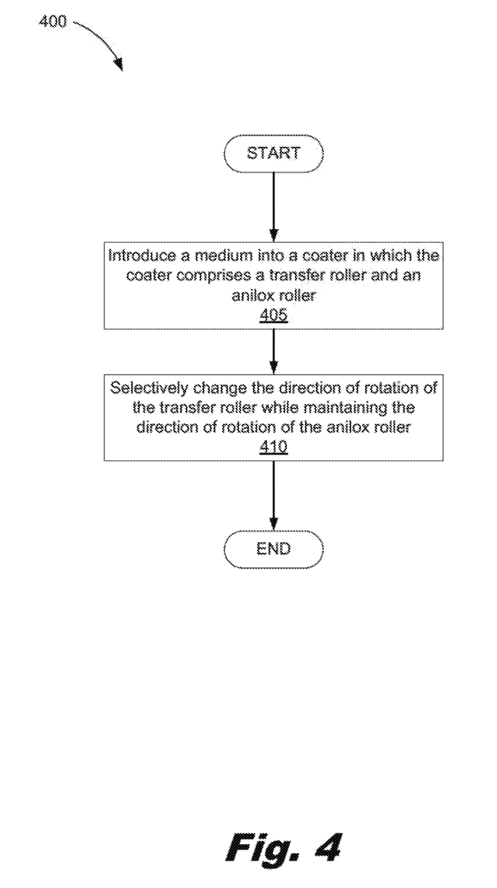

FIG. 4 is a flowchart showing a method (400) of coating a medium according to one example of the principles described herein. The method begins, at block 405, with introducing a medium into a coater in which the coater comprises a transfer roller (FIGS. 2 and 3, 215) and an anilox roller (FIGS. 2 and 3, 210). As described above, the medium may be defined by a user using the GUI and the impression cylinder (FIGS. 2 and 3, 220) may be adjusted accordingly in order to fix the distance between the impression cylinder (FIGS. 2 and 3, 220) and the transfer roller (FIGS. 2 and 3, 215). This may be done automatically by the web coater (FIG. 1, 110) in response to computer instructions received by the computing device (FIG. 1, 115). In another example, the computing device (FIG. 1, 115) may instruct a user on how to adjust the impression cylinder (FIGS. 2 and 3, 220).

The method (400) continues, at block 410, with selectively changing the direction of rotation of the transfer roller (FIGS. 2 and 3, 215) while maintaining the direction of rot n of the anilox miler (FIGS. 2 and 3, 210), As described above, this may be done automatically based on the type of medium (FIGS. 1, 2, 3, 105) selected to be coated by the user using the GUI of the computing device (FIG. 1, 115). Additionally, the rotation of the anilox roller (FIGS. 2 and 3, 210) is maintained, in order to create a sheering film split of the fluid between the anilox roller (210) and the transfer roller (215) while the transfer roller (FIGS. 2 and 3, 215) is rotating in either direction,

In one example, the computer usable program code described above may also further comprise computer usable program code that, when executed by a processor, executes the method as described in FIG. 4. Specifically, the compute readable storage medium may comprise computer usable program instructions to, when executed by a processor, introduce a medium into a water in which the coater comprises a transfer roller (FIGS. 2 and 3, 215). The computer usable program instructions may further comprise computer usable program instructions to, when executed by a processor, selectively changes the direction of rotation of the transfer roller (FIGS. 2 and 3, 215).

The specification and figures describe a system for hybrid coating of a medium. This system and method may have a number of advantages, including the provision of a single piece of hardware that can be used to coat a relatively wider variety of mediums without suffering the disadvantages as described above. This further alleviates a user from having to switch out rollers in order to accommodate the coating of two different types of mediums. The method described above is chic to apply coating containing large particles without having discontinuities in the coating thickness over the surface of the medium. The system and method described above allows a commercial printer to accept a number of different types of printing jobs regardless of the medium on which the printing is to be printed on and coated.

The preceding description has been presented to illustrate and describe examples of the principles described. This description is not intended to be exhaustive or to limit these principles to any precise form disclosed. Many modifications and venations are possible in light of the above teaching.

What is claimed is:

1. A system for hybrid coating of a medium, comprising:
a computing device; and
a web coater, the web coater comprising a transfer roller and an anilox roller;
in which the computing device selectively cause the transfer roller to reverse direction while the anilox roller maintains a single direction of rotation.

2. The system of claim 1, in which selectively causing the transfer roller to reverse direction provides for selective flexographic coating and reverse kiss coating to be used to apply coating to the medium.

3. The system of claim 2, in which high coat weights of 2-3 grams per square meter is coated to the medium via reverse kiss coating.

4. The system of claim 1, in which selectively causing the transfer roller to reverse direction is done by an independent drive mechanism coupled to the transfer roller.

5. The system of claim 1, in which the anilox roller provides fluid from a fluid chamber to the transfer roller.

6. The system of claim 5, in which the transfer roller and anilox roller are separated by a distance of 1 to 2 thousands of an inch.

7. The system of claim 1, further comprising an impression cylinder that translates the medium between the transfer roller and the impression roller.

8. A coater comprising:
a transfer roller; and
an anilox roller;
in which the coater may selectively change the direction of rotation of the transfer roller while the anilox roller maintains a single direction of rotation.

9. The coater of claim 8, in which selectively changing the rotation of the transfer roller provides for selective flexographic coating and reverse kiss coating to be used to apply coating to the medium.

10. The coater of claim 8, in which the transfer roller and anilox roller are separated by a distance of 1 to 2 thousands of an inch.

11. The coater of claim 8, in which selectively changing the rotation of the transfer roller is done by an independent drive mechanism coupled to the transfer roller.

12. The coater of claim 8, further comprising an impression cylinder that translates the medium between the transfer roller and the impression roller.

13. A method of coating a medium, comprising:
introducing medium into a coater, the coater comprising a transfer roller and an anilox roller; and
selectively changing the direction of rotation of the transfer roller while maintaining the direction of rotation of the anilox roller.

14. The method of claim 13, in which selectively changing the direction of rotation of the transfer roller provides for selective flexographic coating and reverse kiss coating to be used to apply coating to the medium.

15. The method of claim 13, in which changing the direction of rotation of the transfer roller is done by an independent drive mechanism coupled to the transfer roller.
